(19) United States
(12) Patent Application Publication
(10) Pub. No.: US 2003/0129279 A1
(43) Pub. Date: Jul. 10, 2003

(54) Clear fruit and vegetable juices and methods for making same

(76) Inventors: Yves Andre Gerard Coutel, Ennevelin (FR); Pierre Clement Louis Fauquembergue, Seclin (FR); Catherine Marie Therese Grassin, Seclin (FR)

Correspondence Address: Kate H Murashige, Morrison & Foerster, Suite 500, 3811 Valley Centre Drive, San Diego, CA, 92130-2332, US

(21) Appl. No.: 10/182,176

(22) PCT Filed: Jan. 24, 2001
(86) PCT No.: PCT/EP01/00776

(30) Foreign Application Priority Data
Jan. 24, 2000 (EP) 00200264.0

(51) Int. Cl. A23K 1/00

(52) U.S. Cl. 426/51

(57) ABSTRACT

The present invention relates to a process for the production of clear juice concentrates from fruit or vegetables and clear juices made thereof. The invention further relates to clear juice concentrates and clear juices made thereof.

### FIELD OF THE INVENTION

The present invention relates to a process for the production of clear juice concentrates from fruit or vegetables and clear juices made thereof. The invention further relates to clear juice concentrates and clear juices made thereof.

### BACKGROUND OF THE INVENTION

The production of juices from fruit and vegetables typically involves, after an optional washing step, grinding, crushing or otherwise destroying the integrity of the fruit or vegetables thus obtaining a fruit or vegetable pulp. Subsequently, the pulp may be treated with enzymes to decrease soluble pectin, a process generally referred to as maceration. After maceration, the pulp is ready for pressing, leading to a juice fraction and a residue fraction, the latter being referred to as the pomace. The juice obtained after pressing is usually pasteurised, optionally with recovery of the aroma, which may then be added back at the end of the process. In order to obtain a clear concentrate, the pasteurised juice is enzymatically depectinized with the aid of pectinases, optionally pre-concentrated, filtrated, optionally ultra-filtrated and concentrated to obtain a clear concentrate or juice which is ready for shipping and/or blending to obtain a clear apple juice for the consumer market.

A common problem encountered during the production of juices and their storage in warehouses or supermarkets, is browning and the development of turbidity (juice instability) due to oxidation of phenolic compounds. A further problem is the presence of mycotoxins. Each category of these compounds poses its own problems.

Phenolic compounds tend to (co)polymerise after oxidation under the influence of light (especially the UV-component in daylight), of oxidative compounds naturally present in or near the juice, heat, ageing and, last but not least, oxidative enzymes. (Co-)Polymerisation of phenolic compounds, of which catechin is a notable example, leads to a class of compounds referred to as polyphenols. Enzymes involved in the oxidation of phenolic compounds originate from the apples themselves, and are commonly referred to as polyphenoloxidases (PPO's), laccases, tyrosinases and catecholases.

As a consequence of the polymerisation of polyphenols during processing of apples and storage of concentrates and blended juices, the juice and concentrates turn brown and become less attractive to consumers due to turbidity or haze formation. The largely insoluble polyphenols tend to precipitate, leaving an unappetising residue in the juice bottle or cartons. Moreover, the polyphenols are largely responsible for the deterioration of the juice flavour and taste; the effect is best described as a loss of freshness of the juice, a cooked taste and an altered mouthfeel.

A solution to the problem of turbidity in clear apple juices has been suggested by Ferrarini R. et al. (1991) Industrie delle Bevande, 20, 10-17. In order to reduce the turbidity, the authors describe the use of pressurisation and flotation equipment during the production of clear apple juice. In a follow-up paper (Ferrarini, 1996, Industrie delle Bevande, 25, 442-448) it was shown that under the conditions described in the earlier paper (two minutes pressurisation time) a decrease of total polyphenols is observed to 458 ppm before filtration; after filtration under optimised conditions, the total polyphenol content was reduced to 156 ppm. There is still room for considerable improvement, since these values imply an ultimate browning potential, taste deterioration and other losses of quality aspects of the juice that are unacceptable.

Mycotoxins, such as patulin, may cause health problems. Keeping the levels below the government-mandated maximum levels (around 50 ppb) is a constant concern for fruit juice (concentrate) manufacturers and blenders.

### SUMMARY OF THE INVENTION

The invention provides a process for the production of a clear juice concentrate from fruit or vegetables comprising:

(a) subjecting a juice fraction from fruit or vegetables to pressurisation

(b) removing insoluble particles from the pressurised juice

(c) followed by filtration and concentration of the juice to a desired Brix value,

which process is characterised by applying an elevated molecular oxygen concentration in the juice fraction during the pressurisation by using an oxygen containing gas as pressurisation gas and maintaining this elevated molecular oxygen concentration for a period sufficiently long to oxidise phenolic compounds present in said juice and, optionally, adding a polyphenol oxidase and/or a fining agent to the juice fraction.

In another aspect, the invention provides a process for the production of a clear juice from fruit or vegetables comprising:

producing a clear juice concentrate according clear juice to the process described above;

diluting said clear juice concentrate to a desired Brix value.

In a third aspect, the invention provides a clear juice concentrate from fruit or vegetables that is characterised by having

a total polyphenol content of less than 150 ppm, and/or

a transmission at 440 nm (T440) of >50%, and/or

a patulin content of <25 ppb, and/or

after six months of storage below 5° C., a turbidity of less than 1 NTU (Nephelometry Turbidity Units) and/or

after twelve months of storage below 5° C., a turbidity of less than 2 NTU,

whereby all parameters are measured after dilution of the concentrate to a Brix value of 11.2°.

In a fourth aspect, the invention provides a clear juice from fruit or vegetables that is characterised by having

a total polyphenol content of less than 150 ppm, and/or

a transmission at 440 nm (T440) of >50%, and/or

a patulin content of <25 ppb, and/or

after six months of storage below 5° C., a turbidity of less than 1 NTU and/or

after twelve months of storage below 5° C., a turbidity of less than 2 NTU and/or

after bottling and 6 months of storage at room temperature, a turbidity of less than 2 NTU and/or

after bottling and 12 months of storage at room temperature, a turbidity of less than 3 NTU,

whereby all parameters are measured in the juice at a Brix value of 11.2°.

### DETAILED DESCRIPTION OF THE INVENTION

The invention provides a process for the production of a clear juice concentrate from fruit and vegetables. The process comprises the steps of

(a) subjecting a juice fraction from fruit or vegetables to pressurisation

(b) removing insoluble particles from the pressurised juice

(c) followed by filtration and concentration of the juice to a desired Brix value,

which process is characterised by applying an elevated molecular oxygen concentration in the juice fraction during the pressurisation by using an oxygen containing gas as pressurisation gas and maintaining this elevated molecular oxygen concentration for a period sufficiently long to oxidise phenolic compounds present in said juice and, optionally, adding a polyphenol oxidase and/or a fining agent to the juice fraction.

We have found that in this way a further reduction of the polyphenol and mycotoxin content of juices and concentrates could be obtained.

Generation of the Juice Fraction

The juice may be obtained from both fruit and vegetables. Preferred fruit is non-red fruit such as apple, pear, peach, white grape, apricot, prune, mango, papaya, kiwi, passion fruit, pineapple, coconut, melon and the like. Vegetables may be selected from tomato, celery, artichoke, endive and the like. After an optional washing step, grinding, crushing or otherwise destroying the integrity of the fruit or vegetables, a fruit or vegetable pulp is obtained. The actual method is not critical and those of skill in the art could readily think of alternatives for the above processes.

Optionally, the pulp is macerated with a macerating enzyme composition. Macerating enzyme composition comprise at least pectinases. The pectin backbone consists primarily of a homogalacturonan polymer which can be degraded by pectin lyases or a combination of polygalacturonases and pectin (methyl) esterases. Therefore, a combination of polygalacturonases and pectin-esterases is especially effective in breaking down the main structure of the pectin. Also liquefying enzymes may be used in addition to or instead of a macerating enzyme composition, if methods such as centrifugation or ultrafiltration are used to remove insoluble particles (including polyphenols) after the pressurisation step. The juice fraction may now be generated by pressing the pulp. This may be followed by a heat treatment and, optionally, by recovery of aroma compounds.

Second Juice Fraction

In this way, also a pomace fraction is generated, which consists primarily of cell walls which, depending on the fruit or vegetable, are rich to very rich in pectin. The pomace is suitably further processed by adding water and, optionally the pomace slurry is macerated, preferably with a macerating enzyme composition which may be the same as the macerating enzyme composition used for the pulp. After pressing the pomace slurry a second juice fraction and a waste fraction are obtained. The second juice fraction may be combined with the juice fraction obtained after pressing the pulp (i.e. the first juice fraction).

Pressurisation

The juice fraction which is of much lower viscosity than the pulp it originated from, may now be subjected to pressurisation for a period long enough to oxidise phenolic compounds present in the juice. Since the oxygen concentration decreases due to oxygen consumption by the oxidative processes in the juice, it is preferred to keep the oxygen concentration more or less constant at an elevated level. Preferably the molecular oxygen concentration is >1 ppm, more preferably >4 ppm and most preferably >5 ppm, concentrations which can be reached only under pressurisation. With higher oxygen concentrations, shorter oxidation times are needed.

The elevated molecular oxygen concentration is achieved by using an oxygen containing gas pressurisation gas. Preferred pressurisation gasses are molecular oxygen, air and ozone. Most preferred is air (no cost, high safety).

The combination of the following parameters is important: oxygen concentration (which is a function of the oxygen concentration of the pressurisation gas and its pressure), oxidation time, replenishment, temperature and the amount of active PPO present. Also the extent of polyphenol removal is determining the parameters of the oxidative process.

An elevated molecular oxygen concentration in the juice is obtained by:

pressurising a volume representing at least 1/10 of the total volume of the juice at an elevated pressure of >1 bar, preferably >2 bar, more preferably >3 bar, using preferably air as pressurisation gas for about 1-2 minutes in a pressurisation tank while the remainder of the juice is kept in the holding tank, followed by

mixing the pressurised part of the juice with the remainder of the juice in the holding tank, so that every few minutes the oxygen concentration of the juice in the holding tank is increased,

and repeating these steps for a total time between 10-120 minutes, preferably 20-120 minutes and more preferably 30-120 minutes.

Alternatively, an elevated molecular oxygen concentration in the juice is obtained by passing the juice batchwise through the pressurisation tank and maintaining each batch at an elevated pressure of >1 bar, preferably >2 bar, more preferably >3 bar, for more than 2, preferably more than 3 minutes, prior to removing insolubles.

Prior to, during or after pressurisation, the juice may be depectinised with enzymes. The subsequent step is separating the insoluble polyphenols from the juice.

Oxidation of Phenolic Compounds

If two juice fractions were combined before pressurisation, at least one of them comprises endogenous PPO activity that catalyses the oxidation of phenolic compounds during the pressurisation step. Therefore, preferably either the first juice fraction or the second juice fraction is subjected to a heat treatment such as pasteurisation. Heat treatment will destroy PPO activity and will also lower the oxygen concentration in the juice. In case total liquefaction, advanced extraction or the hot break process is applied to destroy the integrity of the fruits and the vegetables, addition of exogenous PPO may be necessary in order to achieve the full benefit of the pressurisation and further steps of the process according to the invention. If both juice fractions are subjected to a heat treatment, or in case the endogenous PPO activity of the fruit or vegetable is too low, still some chemical oxidation will occur, but longer oxidation times than with PPO present will be needed. Juice fractions that are not heat treated lead to a higher oxygen concentration of the combined juice fractions, resulting in better pressurisation, reflected in e.g. lower polyphenol levels.

Removal of Insoluble Particles

Insolubles may now be removed by any method known in the art. Preferred ways of doing this are by ultrafiltration or flotation. If flotation is used, the juice is transferred to the flotation tank in a pressurised state. Flotation is carried out in a flotation tank by releasing the pressure, or more in general, by lowering the pressure to, usually, atmospheric pressure, because in general this is the pressure at which the remainder of the process is carried out. We will refer to lowering the pressure by using the term “depressurisation”. The flotation tank juice has ancillary equipment and dimensions which assist in the clarification of the juice. An aspiration device fitted on the flotation tank is used to remove the bulk (about 80%) of the insoluble parts (lees), including the oxidised phenolic compounds. A preferred way of removing the remainder of the polyphenols after removal of the bulk by aspiration during or following flotation, or pumping of clear juice from the holding tank, is ultrafiltration, or cross-flow filtration described by Ferrarini et al. (1991 and 1996, supra). Residual juice may be recovered from the lees fraction, for example, by vacuum-filtration, and combined with the clear juice from the flotation tank.

Optionally, the juice is next subjected to a clarification step. This is preferably carried out using the depectinising enzymes, such as pectinases and amylases. Those of skill in the art know what is meant by the clarification of juice and will know how to perform it.

In a subsequent step, the juice is the filtered, optionally with the aid of active carbon and other fining agents. Filtration, in particular ultrafiltration, aids in removing undesired compounds such as the polyphenols and the like. Those of skill in the art would know how to choose the means and conditions of filtration. A few useful techniques and parameters are described in Ferrarini et al. 1991, supra.

Finally, the juice is concentrated, preferably by evaporation, to obtain the juice concentrate with a desired Brix value, preferably 700, and traded as a concentrate.

A preferred embodiment of the process comprises (see also the process scheme):

(a) optionally washing the fruit or vegetables;

(b) grinding, crushing or otherwise destroying the integrity of the fruit or vegetable thus obtaining a fruit or vegetable pulp;

(c) optionally macerating said pulp, preferably with a macerating enzyme composition;

(d) pressing the pulp thereby generating a juice fraction and a pomace fraction;

(e) separating the juice fraction from the pomace; and optionally pasteurising it and recovering aroma compounds;

(f) optionally adding to said juice a depectinizing enzyme composition;

(g) pressurising the juice from step (f);

(h) transferring the juice in a pressurised state to a flotation tank followed by depressurizing and removing part of the insoluble particles that have come floating to the surface of the juice;

(i) separating the remainder of the insoluble particles;

(j) optionally adding a clarifying enzyme composition to the juice from step (i) to obtain a clear juice;

(k) ultrafiltrating the clear juice followed by further concentrating the ultrafiltrated juice to obtain the clear concentrate with a desired Brix value,

which process is characterised by applying an elevated molecular oxygen concentration in the juice obtained in step (f) during the pressurisation step (g) by using an oxygen containing gas as pressurisation gas and maintaining this elevated molecular oxygen concentration for a period sufficiently long to oxidise phenolic compounds present in said juice and, optionally, adding a polyphenol oxidase and/or a fining agent to the juice obtained in step (d).

The advantages of the process according to the invention are illustrated with apples in Example 1. In terms of product quality, the juice concentrate has a lower total polyphenol content (around 60 ppm compared with 150 ppm for the lowest values seen in prior art juices) which results in a lower ultimate browning potential (better colour stability), a lower turbidity development during prolonged storage times (6 months and more) and a fresher taste and a better mouthfeel. The production process is more economic in that there is no need to add exogenous PPO, there is no, or at least less, need for the addition of exogenous fining agents, such as bentonite, gelatine, kieselsol, active carbon or PVPP. Due to the reduced use of fining agents, ultrafiltration is more efficient, the juice losses are reduced, filter fouling is reduced leading to an extended life-time of the ultramembranes and less loss of processing capacity due to maintenance or cleaning or replacement of the membranes. The flux rate increases drastically due to the lower polyphenol content of the juice. The investment necessary for the pressurisation/flotation equipment is compensated for by these advantages alone; the premium that can be put on the higher quality juice is a further incentive to the processor as well as to the blender/juice makers.

It is envisaged that similar advantages may be obtained when the process is applied to other fruits and vegetables, or blends thereof, although it will be clear that the process according to the invention may require optimisation whenever other fruits or vegetables are being processed.

According to another aspect, the invention provides a process for the production of clear juices from fruit or vegetables which comprises the production of a juice concentrate according to the process of the invention, followed by dilution with water and/or other juices and/or ingredients, such as flavour, aroma, colour and the like, to obtain a juice which is ready for consumption. In one embodiment, the clear juice concentrates are diluted with water to a desired Brix value, preferably 11.2°.

According to a further aspect of the invention a clear juice concentrate from fruit or vegetables is provided that is characterised by having

a total polyphenol content of less than 150 ppm, preferably less than 100 ppm, more preferably less than 60 ppm, and/or

a transmission at 440 nm (T440) of >50%, preferably >60% and/or

a patulin content of <25 ppb, more preferably <10 ppb and most preferably <5 ppb and/or

after six months of storage below 5° C., a turbidity of less than 1 NTU and/or

after twelve months of storage below 5° C., a turbidity of less than 2 NTU,

whereby all parameters are measured after dilution of the concentrate to a Brix value of 11.2°.

According to another aspect of the invention a clear juice from fruit or vegetables is provided that is characterised by having

a total polyphenol content of less than 150 ppm, preferably less than 100 ppm, more preferably less than 60 ppm, and/or

a transmission at 440 nm (T440) of >50%, preferably >60% and/or

a patulin content of <25 ppb, preferably <10 ppb and more preferably <5 ppb and/or

after six months of storage below 5° C., a turbidity of less than 1 NTU and/or

after twelve months of storage below 5° C., a turbidity of less than 2 NTU and/or

after bottling and 6 months of storage at room temperature, a turbidity of less than 2 NTU and/or

after bottling and 12 months of storage at room temperature, a turbidity of less than 3 NTU,

whereby all parameters are measured in the juice at a Brix value of 11.2°.

According to a preferred embodiment, an apple juice is provided having a total polyphenol content of less than 150 ppm, preferably less than 100 ppm, more preferably less than 60 ppm and/or a transmission at 440 nm (T440) of >50%, preferably >60% and/or a patulin content of <25 ppb, preferably <10 ppb and more preferably <5 ppb and/or after six months of storage below 5° C., a turbidity of less than 1 NTU and/or after twelve months of storage below 5° C., a turbidity of less than 2 NTU and/or after bottling and 6 months of storage at room temperature, a turbidity of less than 2 NTU and/or after bottling and 12 months of storage at room temperature, a turbidity of less than 3 NTU, whereby all parameters are measured in the juice at a Brix value of 11.2° and which is obtainable by a process according to the invention.

Table 1 shows some quality parameters of 10 commercially available apple juices. Polyphenolic compounds were determined with Folin Ciocaltieu reagent using catechol as a reference. The T440 values have been determined again 70 days (in brackets) after purchasing the juices. Comparing these values with the initial values illustrates the severe browning problem of commercially available apple juices. The speed of browning is considerable; the T440 dropped to 50% of the initial value in the best case (juice no. 9) and to 25% in the worst cases (juices 4 and 10) in slightly more than 2 months. Although not illustrated in Table 2, there is a correlation between the degree of browning and the taste (freshness) of the juice; the more browning of the juice the less fresh is its taste.

The age of the apple juices at the time of purchasing was not known and, unless the correlation of the browning speed and the age is linear at all ages, it is not possible to correlate the browning speed with the absolute level of polyphenols.

TABLE 1

| | | | | | | | | | | | Poly |
|---|---|---|---|---|---|---|---|---|---|---|---|
| | | | | | | | | OD at | OD at | T440 | phenol |
| Nr | Apple juice | Trademark | Emballage | Density | °Brix | pH | NTU | 420 nm | 520 nm | (%) | (ppm) |
| 1 | 100% pure juice | JAVA | Tetrapak ® | 1.04 | 11.1 | 3.50 | 3.7 | 0.44 | 0.11 | 46.0 | 477 |
| | | | | | | | | | | (12.1) | |
| 2 | juice on | REA | | 1.04 | 11.1 | 3.40 | 4.8 | 0.42 | 0.08 | 51.3 | 495 |
| | concentrate | | | | | | | | | (21.3) | |
| 3 | basis | RIK | | 1.04 | 10.9 | 3.55 | 15.2 | 0.56 | 0.17 | 34.4 | 275 |
| | | | | | | | | | | (13.7) | |
| 4 | | JOKER | | 1.05 | 10.9 | 3.61 | 24.6 | 0.59 | 0.16 | 35.7 | 272 |
| | | | | | | | | | | (9.2) | |
| 5 | | CORA | | 1 .04 | 11.0 | 3.40 | 7.6 | 0.42 | 0.09 | 50.3 | 499 |
| | | | | | | | | | | (19) | |
| 6 | | CORA | | 1.04 | 11.0 | 3.39 | 7.2 | 0.41 | 0.09 | 50.8 | 480 |
| | | | | | | | | | | (18.5) | |
| 7 | | MINUTE | | 1.04 | 10.8 | 3.33 | 2.0 | 0.38 | 0.10 | 50.2 | 231 |
| | | MAID | | | | | | | | (22.3) | |
| 8 | | MINUTE | | 1.04 | 10.8 | 3.33 | 2.1 | 0.38 | 0.10 | 50.0 | 230 |
| | | MAID | | | | | | | | (21.8) | |
| 9 | 100% juice | REA | Glass | 1.05 | 12.0 | 3.32 | 5.1 | 0.27 | 0.04 | 65.6 | 528 |
| | (freshly pressed) | | bottle | | | | | | | (35.7) | |
| 10 | 100% pure juice | PAMPRYL | | 1.05 | 12.2 | 3.35 | 19.0 | 0.34 | 0.162 | 53.1 | 433 |
| | | | | | | | | | | (12.2) | |

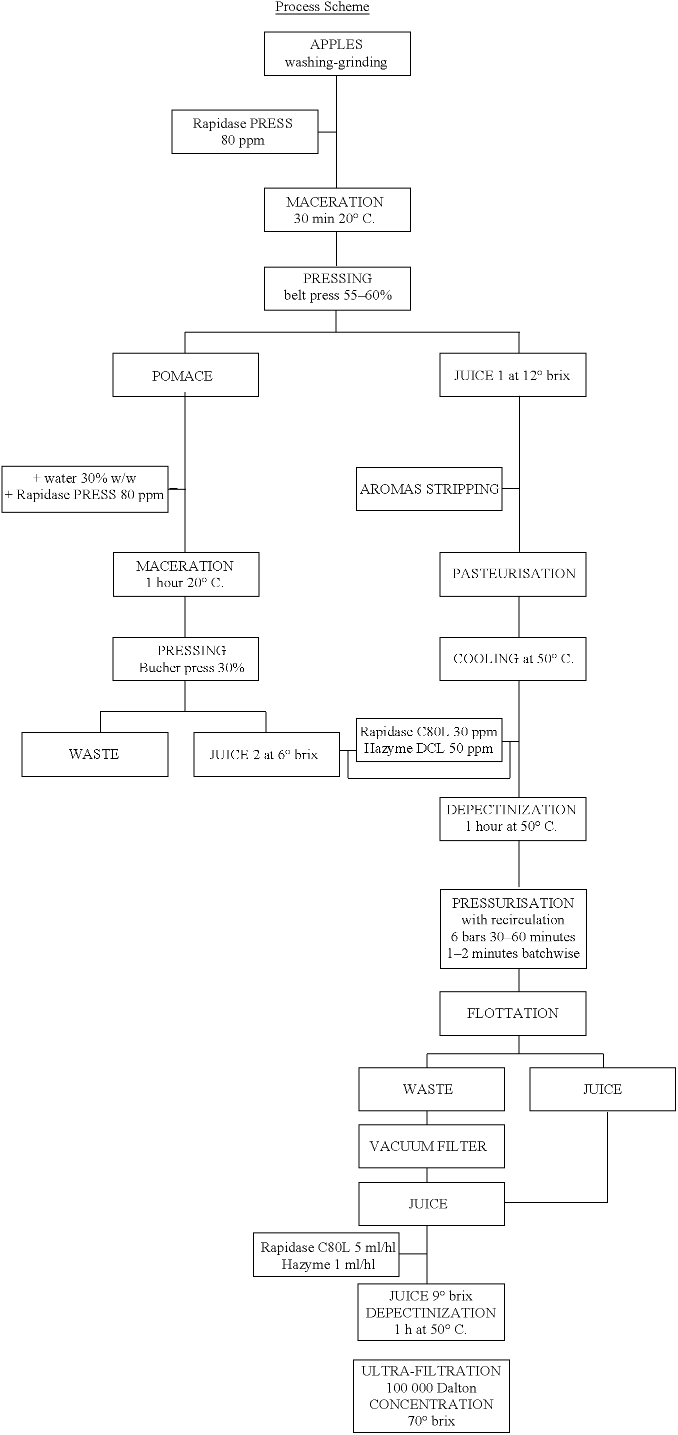

### EXAMPLE 1

About 1 week post-harvest, thirty tons of apples (a mixture of Golden Delicious, Red Delicious and Granny Smith in a ratio of 1:2:2) were processed for juice concentrate production according to the Process Scheme.

After washing and during grinding, a macerating enzyme composition (RAPIDASE PRESS from DSM Food Specialties—Beverages Ingredients Group—Lille, France) was added to a final concentration of 80 ppm. The pulp with enzymes was maintained for 60 minutes at 20° C. The pulp was pressed with a belt press (yield 55 to 60%). The juice (called first juice) and the pomace were then processed separately.

The first juice (170 hectolitres) was pasteurised and aroma compounds were recovered (aroma stripping). The juice was then cooled to a temperature of about 50° C. by combining the pasteurised juice fraction and the second juice fraction (obtained from the pomace processing—see below). Then a clarifying enzyme composition was added in the form of RAPIDASE C80 and HAZYME DCL (both from DSM Food Specialties—Beverages Ingredients Group—Lille, France) at final concentrations of 30 and 50 ppm respectively for the depectinization and starch degradation. The incubation lasted 1 hour at a starting temperature of about 50° C.; the end temperature was slightly lower due to spontaneous cooling (48° C.).

The pomace was diluted with water (slurry containing 30% w/w) and treated with the macerating enzyme composition described above (RAPIDASE PRESS—final concentration of 80 ppm) for one hour at 20° C. The pomace was then pressed with a hydraulic press (yield 30%). The waste was discarded (sometimes washed a second time) and the juice (called second juice—80 hectolitres) was added to the first juice.

The blend of both juices was transferred to a pressurisation tank associated to a flotation tank and ancillary equipment, including an aspirator. The juice was subjected to a pressure of 6 bar in a pressurisation tank using air as pressurisation gas; the total juice volume (250 hectolitre) was pressurised batch-wise (batch size about 25 to 30 hectolitres) in a pressurisation tank (3 m³) for about 2 minutes at a temperature of about 50° C. After pressurisation the juice was combined with the remainder of the juice in the holding tank, whereafter a new batch from the juice in the flotation tank was led into the pressurisation tank followed by 2 minutes pressurisation; this batchwise treatment was carried out for 45 minutes in total. This treatment led to a molecular oxygen content of the juice in the holding tank of between 5 and 6 ppm.

Subsequently, the juice was led batchwise via the pressurisation tank into a flotation tank (TECNOIMPIANTI—Ospedaletto Euganeo, Italy), each batch remaining in the pressurisation tank for 1 to 2 minutes at 5 to 6 bar. While feeding the juice in the flotation tank, gelatine was added at 10-20 grams per hectolitre. Flotation was allowed to proceed and the insoluble parts (lees) were removed from the surface of the juice using an aspirator; this fraction was filtered using a vacuum filter and the recovered juice was combined with the clear juice from the flotation tank. The juice of the combined fractions was concentrated to 16° Brix and depectinized (because of the raw second juice) with RAPIDASE C80 at 50 ppm and HAZYME DCL at 10 ppm for 1 hour at about 50° C. The juice was filtered by vacuum-filtration after addition of active carbon at about 1 gram per litre before ultrafiltration on a membrane with a cut-off of 100 kDa and subsequently concentrated to 70° Brix.

Trial B6 was performed according to the process described above.

Trial A6 served as the control since the pressurisation step was carried out for only 2 minutes according to Ferrarini et al. (1991 and 1996). The results are summarised in Table 2.

As the results in the Table 2 point out, absolute levels of polyphenols of the juice made by the process according to the invention is well below 100 ppm. Juice from trial B6 contained only 60 ppm polyphenols while the control juice (A6) contained 153 ppm polyphenols, confirming the results reported by Ferrarini et al., (1991 and 1996).

The browning of the juice concentrate was also evaluated after 12 months storage at 4° C.—see Table 2. As a measure of the browning, the transmission at 440 nm (T440) was measured. The control (A6) had a T440 of 38%, compared to 70% for the juice according to the invention (B6) which means that A6 is much browner than B6. The results expressed as OD (optical density) at 420 nm after 12 months confirm the excellent results obtained with the process according to the invention in terms of browning, compared to the control (see numbers between brackets).

A look at the turbidity (expressed as NTU—the lower the NTU values, the lower the turbidity) after 12 months demonstrates the excellent results obtained with the process according to the invention (B6) as compared to the control (A6)—Table 2.

The patulin content for juice B6 was 5 ppb as compared to 65 ppb for the control A6, which can be explained by modification of the toxin during the prolonged pressurisation of the juice. It is clear that there is no need to treat the concentrate after 6 months again with active carbon—common practice with state of the art concentrates—if it is made by the process according to the invention.

TABLE 2

| | | | | | | | Poly |
|---|---|---|---|---|---|---|---|
| | °Brix | | | OD | T440 | Patulin | phenols |
| Trial | concentrate | PH | NTU | 420 nm | (%) | ppb | (Folin) |
| A6 | 70.1 | 3.76 | 2.2 | 0.41 | 38.0 | 65 | 153 |
| | | | (4.5) | (0.68) | (21.0) | | |
| B6 | 70.0 | 3.76 | 0.2 | 0.15 | 70.0 | 5 | 60 |
| | | | (0.7) | (0.28) | (52.0) | | |

Values between brackets are results obtained after 12 months storage at 4° C. in dark.
All parameters are measured after diluting the concentrate to a Brix value of 11.2°.

1. A process for the production of a clear juice concentrate from fruit or vegetables comprising
(a) subjecting a juice fraction from fruit or vegetables to pressurisation
(b) removing insoluble particles from the pressurised juice
(c) followed by filtration and concentration of the juice to a desired Brix value,
which process is characterised by applying an elevated molecular oxygen concentration in the juice fraction during the pressurisation by using an oxygen containing gas as pressurisation gas and maintaining this elevated molecular oxygen concentration for a period sufficiently long to oxidise phenolic compounds present in said juice and, optionally, adding a polyphenol oxidase and/or a fining agent to the juice fraction.

2. A process according to claim 1, wherein the fruit is non-red fruit.

3. A process according to claim 2, wherein the non-red fruit is apple.

4. A process according to any of claims 1-3, wherein the elevated molecular oxygen concentration is at least 4 ppm.

5. A process according to any of claims 1-4, wherein the elevated molecular oxygen concentration in the juice is obtained by:
pressurising a volume representing at least 1/10 of the total volume of the juice to be pressurised at a pressure between 3 and 7 bar using air as pressurisation gas for-about 1 to 2 minutes in a pressurisation tank while the remainder of the juice is kept in the holding tank, followed by
mixing the pressurised part of the juice with the remainder of the juice in the holding tank;
and repeating these steps for a total time between 10-120 minutes, prior to removal of insoluble particles.

6. A process according to any of claims 1-4, wherein the juice is transferred to a flotation tank for removal of insolubles by passing the juice batch-wise through the pressurisation tank and maintaining each batch at an elevated pressure, preferably between 3-7 bar, for at least 3 minutes, prior to flotation.

7. A process according to claim 1-6, wherein the juice fraction originated from a combination of several juice fractions.

8. A process according to claim 7, wherein either of the several juice fractions is subjected to a heat treatment.

9. A process according to any of claims 1-8 comprising addition of aroma.

10. A process for the production of a clear juice from fruit or vegetables comprising:
producing a clear juice concentrate according to the process described above;
diluting said clear juice concentrate to a desired Brix value.

11. A process according to claim 10, wherein the fruit is apple.

12. A clear juice concentrate from fruit or vegetables characterised by a total polyphenol content of less than 150 ppm, measured after dilution to a Brix value of 11.2°.

13. A clear juice concentrate according to claim 12 characterised by a transmission at 440 nm of 50% or more, measured after dilution to a Brix value of 11.2°.

14. A clear juice concentrate according to any of claims 12-13 characterised by a patulin content of less than 25 ppb, measured after dilution to a Brix value of 11.2°.

15. A clear juice concentrate according to any of claims 12-14 which, after six months of storage below 5° C., has a turbidity of less than 1 NTU measured after dilution to a Brix value of 11.2°.

16. A clear juice concentrate according to any of claims 12-14 which, after twelve months of storage below 5° C., has a turbidity of less than 2 NTU measured after dilution to a Brix value of 11.2°.

17. A clear juice concentrate according to any of claims 12-16 wherein the fruit is apple.

18. A clear juice from fruit or vegetables characterised by a total polyphenol content of less than 150 ppm, measured at a Brix value of 11.2°.

19. A clear juice according to claim 18 characterised by a transmission at 440 nm of 50% or more, measured at a Brix value of 11.2°.

20. A clear juice according to any of claims 18-19 characterised by a patulin content of less than 25 ppb, measured at a Brix value of 11.2°.

21. A clear juice according to any of claims 18-20 which, after six months of storage below 5° C., has a turbidity of less than 1 NTU measured at a Brix value of 11.2°.

22. A clear juice according to any of claims 18-20 which, after twelve months of storage below 5° C., has a turbidity of less than 2 NTU measured at a Brix value of 11.2°.

23. A clear juice according to any of claims 18-20 which, after bottling and 6 months of storage at room temperature, has a turbidity of less than 2 NTU, measured at a Brix value of 11.2°.

24. A clear juice according to any of claims 18-20 which after bottling and 12 months of storage at room temperature, has a turbidity of less than 3 NTU, measured at a Birx value of 11.2°.

25. A clear juice according to claims 18-24 wherein the fruit is apple.
